(19) United States
(12) Patent Application Publication
(10) Pub. No.: US 2020/0216193 A1
(43) Pub. Date: Jul. 9, 2020

(54) Standalone Electronic Device For Generating Communications While In An Aircraft, And Non-Transitory Computer-Readable Medium And Method Of Generating A Communication For The Same

(71) Applicant: Hangar50 LLC, West Bend, WI (US)

(72) Inventors: Donald J. Muehlbauer, West Bend, WI (US); Mathew J. Muehlbauer, Muskego, WI (US)

(21) Appl. No.: 16/725,208

(22) Filed: Dec. 23, 2019

Related U.S. Application Data
(60) Provisional application No. 62/787,809, filed on Jan. 3, 2019.
(60) Provisional application No. 62/807,048, filed on Feb. 18, 2019.

(51) Int. Cl. B64D 45/00; G08G 5/00; G05D 1/08

(52) U.S. Cl. CPC B64D 45/0005; B64D 2045/0085; G05D 1/0808; G08G 5/0004

(57) ABSTRACT

A standalone electronic device and/or a method for generating a communication while in an aircraft. The device includes a processor and a memory communicably coupled to the processor. The memory and processor have at least one of 1) an aircraft data module including instructions that when executed by the processor help obtain aircraft data from one or more sensors supported by the electronic device and/or the aircraft; 2) a rules module including instructions that when executed by the processor cause the processor to obtain a rule defining an aircraft state; 3) a monitoring module including instructions that when executed cause the processor to monitor whether the rule has been traversed by the aircraft data; and 4) an output module including instructions that when executed cause the processor to generate a communication output upon the rule being traversed. Further embodiments are disclosed for what happens after an alert is generated.

### CROSS-REFERENCE TO OTHER RELATED APPLICATIONS

This application claims the benefit of U.S. Patent Application No. 62/787,809, entitled “Standalone Electronics Device for Generating a Communication While in an Aircraft, and Method and Computer-Readable Medium Performing the Same,” filed on Jan. 3, 2019, the entire content of which is incorporated herein by reference.

This application also claims the benefit of U.S. Patent Application No. 62/807,048, entitled “Standalone Electronics Device for Generating a Communication While in an Aircraft, and Non-Transitory Computer-Readable Medium and Method of Generating a Communication for the Same,” filed on Feb. 28, 2019, the entire content of which is incorporated herein by reference.

### BACKGROUND OF THE INVENTION

### 1. Field of the Invention

The present invention relates to the field of avionics. In some embodiments, the present invention relates to methods and standalone electronic devices for alerting a pilot if an aviation rule has been traversed. In some embodiments, the present invention relates to methods and standalone electronic devices for alerting a pilot if retractable landing gear is not in a gear down position during a perceived landing condition. In some embodiments, the present invention relates to methods and standalone electronic devices for providing a virtual co-pilot, a virtual boss, and/or a virtual certified flight instructor. In some embodiments, the present invention relates to methods and standalone electronic devices for post alert processing upon issuance of an alert. In some embodiments, the present invention relates to defining aviation rules into one or more categories and defining priorities for the rules. In aspects, the rules can be processed as subsets or supersets.

### 2. Discussion of the Related Art

In piloting an aircraft, many things can go wrong. For example, landing without putting the retractable gear down is one of the most common general aviation safety issues. Pilots tend to make mistakes when they are distracted. Distractions can come from anywhere—examples include distractions from air traffic control, air traffic, birds, weather, passengers, etc. It is the nightmare that every retractable-gear pilot fears—a perfect flight, followed by a belly flop on the runway because the pilot forgot or was distracted by a minor event in the cockpit to lower the landing gear. This scenario happens to pilots with a wide range of experience. According to the National Transportation Safety Board, more than half of all reported landing gear related incidents are unintentional gear-up landings.

One solution to the problem is to have a co-pilot monitor the duties of the pilot. For example, co-pilot duties on airliners, among others, are to watch what the pilot is doing (e.g., not putting the landing gear down) and react to anything that seems to be an unusual response to a flight condition (e.g., inform the pilot of the situation or putting the landing gear in a down position). However, there are many times, even in multi-pilot situations, where the official aircraft checklists may be antiquated, or both pilots not follow all checklist items or regulations. Further, a co-pilot may not be available for a flight, for example, in a noncommercial or general flight. Moreover, expensive FAA certified systems (e.g., avionics, autopilot, etc.) are typically not available to the general aviation pilot. As a result, general aviation pilots tend to have a worse safety record compared to larger commercial airline pilots.

In a typical aircraft today, alerts exist either in an ON or OFF condition, without post alert processing. An example is the audible alert for an aircraft stall based on relative wind blowing over a physical tab supported by the wing. When the wing stalls, the tab pops up, and completes a circuit that sounds an audible alert to the pilot. Once the wing is no longer stalled, the tab drops down and opens the circuit. Therefore, the pilot has no control of whether the alert is on or off, and the alert self-clears.

Given the above, what is needed is an apparatus and method to aid a pilot in performing all required tasks to have a safe and successful flight.

### SUMMARY AND OBJECTS OF THE INVENTION

By way of summary, some aspects of the present invention is directed to methods and apparatus for allowing pilots or others to set status messages or alerts when various flight conditions occur as measured by avionics, flight control positions, or other indications. Nearly all flight conditions can be measurable, including airspeed, ground speed, pitch attitude, vertical speed, altitude, and position of aircraft controls such as throttle, brakes, yoke, flaps, gear extended, gear retracted, etc.

In one embodiment, the invention provides a standalone electronic device for generating a communication while in an aircraft. The device includes a processor and a memory communicably coupled to the processor. The memory stores a) an aircraft data module including instructions that when executed by the processor cause the processor to obtain aircraft data, and b) a rules module including instructions that when executed by the processor cause the processor to obtain a rule defining an aircraft state. The memory preferably further includes c) a monitoring module including instructions that when executed by the processor cause the processor to monitor whether the rule has been traversed by the aircraft data, and d) an output module including instructions that when executed by the processor cause the processor to generate a communication output upon the rule being traversed. In embodiments, the aircraft data can be obtained from one or more sensors supported by the standalone electronic device, from one or more sensors of the aircraft, or from both the one or more sensors supported by the standalone electronic device and the one or more sensors of the aircraft.

An additional aspect of the invention could include an Internet-based service where, for a given aircraft type and/or configuration, pilots, vendors, and/or flight departments can share their aircraft conditions and rules for sensors, possibly as a web service, which would also help pilots get a starting set of rules and/or sensors to start and adjust from. A yet additional aspect of the invention could include a standalone electronic device for providing a virtual co-pilot, a virtual boss, and/or a virtual certified flight instructor.

One or more embodiments of the invention provide a cheaper, non-invasive electronic “smart” device to allow smaller aircraft pilots to have some of the benefits of very expensive, certified equipment. Since the electronic device is noninvasive, the device is not permanently connected to aircraft and is qualified as a non-FAA certified device. Embodiments of the invention aim to provide the same high level of information to the general aviation pilot using low cost systems and sensors in a non-FAA certified solution. Embodiments cover concepts and use cases related to determining an aircraft condition and alerting the pilot, or through logging, the aircraft owner/operator, when certain aircraft conditions occur, and a rule is traversed resulting from an alert aircraft condition.

Embodiments of the invention expand on what happens after an alert is generated, and an alert rule is traversed the other direction (e.g., from alert status to normal status or to a different alert status) or additional sensor data traverses different rules. Embodiments of the invention includes the smart device continuing to process sensor status and aircraft condition, and modifying alerts, recommendations, coaching, and logging in near real time to assist the pilot or trainee as conditions and pilot actions change. Also, embodiments of the invention prioritize a plurality of alerts, recommendations, coaching, and logging when multiple events occur concurrently.

In one embodiment, the invention provides a standalone electronic device for generating a communication while in an aircraft. The device includes a processor and a memory communicably coupled to the processor. The memory stores a) an aircraft data module including instructions that when executed by the processor cause the processor to obtain aircraft data. The aircraft data is obtained from one or more sensors supported by the standalone electronic device, from one or more sensors of the aircraft, or from both the one or more sensors supported by the standalone electronic device and the one or more sensors of the aircraft. The memory further stores b) a rules module including instructions that when executed by the processor cause the processor to obtain a rule defining an aircraft state, and c) a monitoring module including instructions that when executed by the processor cause the processor to monitor whether the rule has been traversed a first time by the aircraft data and to monitor whether the rule has been traversed a second time by the aircraft data. The memory also stores d) an output module including instructions that when executed by the processor cause the processor to generate a first communication output upon the rule being traversed the first time and generate a second communication output upon the rule being traversed the second time by the aircraft data. The second traversal can be in the logically-opposite direction from the first traversal.

In another embodiment, the invention provides a standalone electronic device for generating a communication while in an aircraft. The device includes a processor and a memory communicably coupled to the processor. The memory stores a) an aircraft data module including instructions that when executed by the processor cause the processor to obtain aircraft data, and b) a rules module including instructions that when executed by the processor cause the processor to obtain a first rule defining a first aircraft state and a second rule defining a second aircraft state. The memory further stores c) a monitoring module including instructions that when executed by the processor cause the processor to monitor whether the first rule has been traversed by the aircraft data, and d) an output module including instructions that when executed by the processor cause the processor to generate a first communication output upon the first rule being traversed. The monitoring module further includes instructions that when executed by the processor cause the processor to monitor whether the second rule has been traversed by the aircraft data only after the first rule has been traversed by the aircraft data. Also, the output module further includes instructions that when executed by the processor cause the processor to generate a second communication output upon the first rule being traversed.

These, and other aspects and objects of the present invention, will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical embodiments of the present invention, will become more readily apparent by referring to the exemplary, and, therefore, non-limiting, embodiments illustrated in the drawings accompanying and forming a part of this specification, wherein like reference numerals designate the same elements in the several views, and in which:

FIG. 1 is a perspective view of portions of a cockpit of an aircraft including a stand-alone smart device held in the cockpit;

FIG. 2 is a block diagram of portions of the smart device shown in FIG. 1;

FIG. 3 is a block diagram of the smart device shown in FIG. 1 in communication with the aircraft and a remote system;

FIG. 4 if a flowchart for one method of operation for one implementation of the smart device of FIG. 2;

FIG. 5 is a flowchart of first additional operations that can be performed by the smart device of FIG. 2;

FIG. 6 is a flowchart of second additional operations that can be performed by the smart device of FIG. 2;

FIG. 7 is a table representing the percent power setting for a Lycoming O-320 160 horsepower engine;

FIG. 8 is a table representing the FAA airman certification standard (ACS) for a private pilot practical test.

FIG. 9 is a table representing the FAA requirements for a steep turn maneuver.

In describing preferred embodiments of the invention, which are illustrated in the drawings, specific terminology will be resorted to for the sake of clarity. However, it is not intended that the invention be limited to the specific terms so selected and it is to be understood that each specific term includes all technical equivalents, which operate in a similar manner to accomplish a similar purpose.

### DETAILED DESCRIPTION OF THE DRAWINGS

The present invention and the various features and advantageous details thereof are explained more fully with reference to the non-limiting embodiments described in detail in the following description.

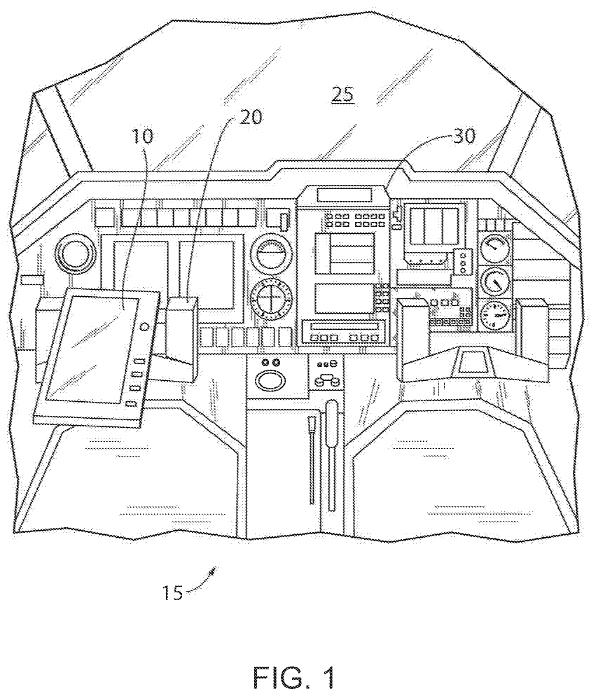

FIG. 1 shows a standalone smart device 10 of the present invention in a cockpit 15 (or flight deck) of an aircraft. FIG. 1 shows the smart device 10 mounted to a pilot's control wheel 20. The cockpit 15 can vary depending on aircraft design, size, and complexity. However, typical elements of a cockpit 15 include an outside view 25 from the cockpit 15; an instrumentation panel 30 including analog, digital, and/or computer displays; and various analog, digital, and/or computer pilot controls (e.g., the control wheel 20). The aircraft also includes many aviation instruments and aircraft sensors that provide input to the cockpit 15. The aircraft and the cockpit 15 can include many other elements not discussed herein but known to one skilled in the art that can or may be used to help the pilot fly the aircraft. For a first simple example, the cockpit 15 may include a speaker or headset for the pilot. For another simple example, the aircraft may include one or more antennas for communicating outside of the aircraft (e.g., with a control tower) or within the aircraft (e.g., with the smart device 10).

The smart device 10 is shown in FIG. 1 as a tablet computer. However, the smart device 10 can be one of other standalone devices such as a smart phone, notebook and netbook computers, and the like. The smart device 10 can be more generically referred to as an electronic device.

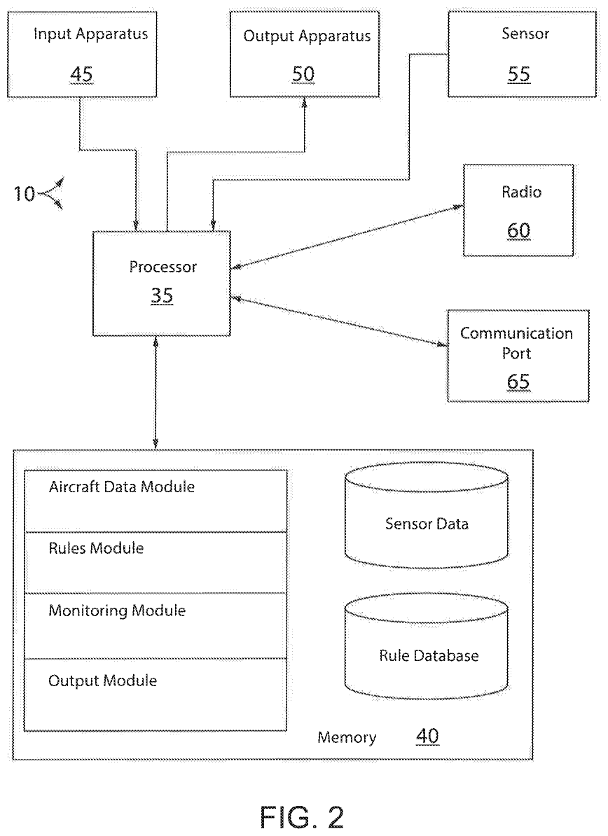

FIG. 2 schematically shows an arrangement for portions of the smart device 10. The smart device 10 includes various components common to many typical smart devices, including a processor 35, a memory 40, an input apparatus 45, an output apparatus 50, an internal sensor 55, and a radio 60. While one of each component is shown, the smart device 10 can include a plurality of one or more of the components. The smart device 20 preferably includes processing power, memory, and instructions to perform tasks, run programs, and interact substantially with a pilot. The smart device 10 is what one skilled in the art typically considers as a standalone (or noninvasive) device from the aircraft.

As mentioned, the smart device 10 has a processor 35 and a memory 40. While the arrangement of FIG. 2 shows a single processor 35 and a single memory 40, it is envisioned that many other arrangements are possible. For example, multiple elements of the smart device 10 can include a distinct processor 35 and memory 40.

The processor 35 can include a component or group of components that are configured to execute, implement, and/or perform any of the processes or functions described herein or a form of instructions to carry out such processes or cause such processes to be performed. Examples of suitable processors 35 include a microprocessor, a microcontroller, and other circuitry that can execute software. Further examples of suitable processors 35 include, but are not limited to, a core processor, a central processing unit (CPU), a graphical processing unit (GPU), an array processor, a vector processor, a digital signal processor (DSP), a field-programmable gate array (FPGA), a programmable logic array (PLA), an application specific integrated circuit (ASIC), math co-processors, and programmable logic circuitry. The processor 35 can include a hardware circuit (e.g., an integrated circuit) configured to carry out instructions contained in program code. In arrangements in which there are a plurality of processors 35, such processors 35 can work independently from each other or one or more processors 35 can work in combination with each other.

The smart device 10 includes a memory 40 for storing one or more types of data. The memory 40 can include volatile and/or non-volatile memory. Examples of suitable memory 40 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, disks, hard drives, or other suitable storage medium, or any combination thereof. The memory 40 can be a component of the processor 35, can be operatively connected to the processor 35 for use thereby, or a combination of both.

In one or more arrangements, the memory 40 can include various instructions stored thereon. For example, the memory 40 can store one or more modules. Modules can be or include computer-readable instructions that, when executed by the processor 35, cause the processor 35 to perform the various functions disclosed for the module. While functions may be described herein for purposes of brevity, it is noted that the functions are performed by the processor 35 using the instructions stored on or included in the various module described herein. Some modules may be stored remotely and accessible by the processor 35 using, for instance, various communication devices and protocols.

The smart device 10 may communicate wirelessly through various radios 60, such as a wireless radio. Examples of a wireless radio 60 include a wireless wide area network (WWAN) radio and a wireless local area network (WLAN) radio, such as a WIFI™ radio, a BLUETOOTH® radio, and the like. If a WWAN radio is included as one of the radios 60 in the wireless radio, communication would generally be allowed to communicate over a long-range wireless communication network such as 3G, 4G, LTE, 5G, satellite and the like.

The smart device 10 may also provide communication and network access through a wired connection communication port 65. The wired connection may connect to a communication network of the aircraft.

The smart device 10 includes an input apparatus 45. An input apparatus 45 includes a device, component, system, element, or arrangement or groups thereof that enable information/data to be entered into the smart device 10. The input apparatus 45 can receive an input from an aircraft passenger (e.g. a pilot, a co-pilot, an instructor). The smart device 10 also includes an output apparatus 50. An output apparatus 50 includes any device, component, or arrangement or groups thereof that enable information/data to be presented to an aircraft passenger (e.g. a pilot, a co-pilot, an instructor).

The smart device 10 may have one or more internal sensors 50 that may be used by the smart device 10 to determine the location and/or orientation of the smart device 10. For example, the smart device 10 may include a Global Positioning System (GPS) sensor, a pressure sensor, a compass, an accelerometer, a gyroscope, and more. The GPS sensor may be used for location of the smart device 10 and to determine a ground vector. A ground vector is the velocity and the direction of travel of the smart device 10. The compass may be used to determine a lateral angle of the smart device 10. The accelerometer may be used to determine movement around an axis. A gyroscope or accelerometer may be used to determine a vertical angle or pitch of the smart device 10. For example, the accelerometer may be used to determine movement around an axis, and the gyroscope may be used to determine position around an axis.

Inexpensive and widely adopted smart devices often include sensors, such as position sensors. The accuracy, stability, and reliability of the sensors are generally insufficient for aviation use as determined by the Federal Aviation Administration. One reason is that aircraft have harsh environments for electronic due to electrical and magnetic interference and jolting physical motion. Accordingly, external sensors 70 may also be in communication with the smart device 10. Data from the external sensors 70 may supplement or replace some of the data from the internal sensors 55.

For example, the smart device 10 may lack one or more of the internal sensors 55 described above. The external sensors 70 may be used to provide information not produced by the internal sensors 55. Moreover, in some cases the external sensors may be more accurate than the internal sensors 55. The external sensors 70 may include avionic sensors, an external GPS sensor, an attitude and heading reference system (AHRS), a pitot static system, and an aircraft engine data system. Avionic sensors may detect heading, speed, altitude, and wind data that may be used to define an aircraft vector. The external GPS may be embedded in an Automatic Dependent Surveillance-Broadcast (ADS-B) and provide location, altitude, and a ground vector. The AHRS may provide aircraft pitch, roll, and yaw.

The smart device 10 can use input from its internal sensors 55 and input from any number of external sensors 70 simultaneously or independently. For example, in one mode, the smart device 10 may only use the internal sensors 55. The smart device 10 may use its GPS to determine a location of and to track the aircraft. The smart device 10 may use its compass to determine a lateral angle. The smart device 10 may use its accelerometer or gyroscope to determine vertical angle. A second mode may improve accuracy by using the external sensors 70. The external sensors 70 may provide more accurate information to the smart device 10. In some embodiments, if an external GPS is in communication with the smart device 10, the external GPS data will replace or augment any internal GPS data to improve accuracy. The replacement of sensors 55 may be automatic when paired through Bluetooth, for example, or other connections. The smart device 10 may also suppress sensor data that is susceptible to perturbations during aircraft maneuvering.

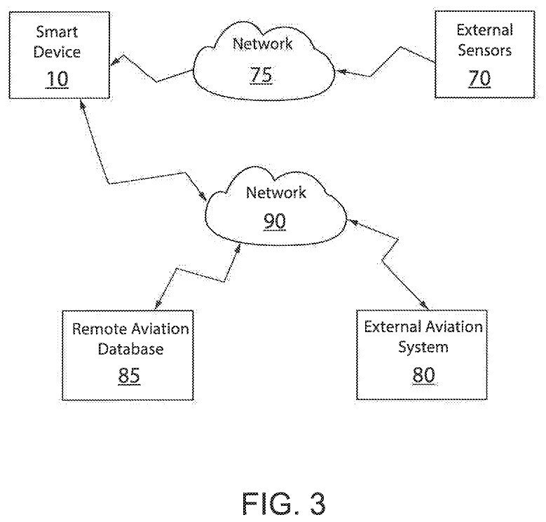

In some embodiments, the smart device 10 may broadcast data to devices connected beyond the aircraft via another network using a wireless device and/or system. This may allow a remote system to view acquired data from the aircraft, and more specifically the smart device 10. Similarly, the smart device 10 may receive data via the remote network. FIG. 3 shows a functional interaction between the smart device 10, external sensors 70 of the aircraft via first network 75, an external aviation system 80 (e.g., of a control tower), and a remote aviation database 85. The communication among the smart device 10, the external aviation system 80, and the remote aviation database 85 is via a second network 90.

Without limitation, a few additional examples of the smart device 10 acquiring data from the aircraft and external aviation systems 80 of the smart device 10 are below.
Using cameras and/or sensors to determine whether lights on the instrument panel 30 are lit as one communication method (camera or light sensor).
Sensing whether a current of the light is flowing by wrapping around existing instrument wiring without permanently connecting to the aircraft.
Utilizing sensors (such as sensing if a flap is extended or not) at the location of the flap and sending that information via networking through the ground plane or fuselage of the aircraft.

One common problem is an aircraft landing with its gear up. The scenario could be minimally solved with simply a small electronic device (e.g., utilizing Arduino or Raspberry PI) combined with a GPS antenna and software. As smart devices like iPads already have the processing power and the GPS antenna built in, the entire solution can be solved by an application. When a limit airspeed and vertical speed are reached per GPS data, a “Check Gear Position” alert could be sent to the pilot. A more robust version with the addition of hardware sensors to verify if the gear is currently up or down and change the alert to, for example, “the gear is down, proceed to landing” versus “Gear Up, Gear Up” repeated until the pilot silences the alarm.

In some implementations, a more general “automated co-pilot” could use data currently available to pilots and optionally data available from additional non-invasive sensors to determine the flight status of the aircraft. This flight status can then be compared to a library or table of flight statuses defined by the user or pulled from a stored library of flight statuses. The library would also store what the desired pilot action should be to that flight status. The desired pilot action can be communicated to the pilot by various means, including lighting lights, sounding alerts, playing recorded messages, tactile feedback, or other means.

The smart device 10 according to some embodiments of the invention centrally collects information available about flight conditions, allows a user (e.g., a pilot) to collect desired sets of flight conditions into a flight scenario, and selects the response to that flight scenario as far as a notification or warning. The types of response may be light a light, buzz a haptic device, play a recorded message, issue an alert on a different screen of a general computing platform, or repeat a warning/alarm/message until the pilot silences the alarm. Furthermore, a user can record custom messages, often with different voices, for different levels of alert. Accordingly, monitored aircraft conditions can be simple or complex.

A. Safety Warning System—Gear Alerting—Virtual Co-Pilot

The inventors started out thinking about the problem of landing a retractable gear aircraft without putting the gear down, as discussed above. This scenario happens to pilots with a wide range of experience. According to the U.S. National Transportation Safety Board (NTSB), more than half of all reported landing gear related incidents are unintentional gear-up landings. Industry experts forecast that thirty or more pilots will land gear up this year. When this happens, insurance costs can be from a low in the $50,000 range, up to the millions of dollars.

Typical general aviation aircraft equipped with retractable gear have no warning system to alert the pilot when to put the gear down. The aircraft typically have one to three green lights to indicate that the gear is down and locked, and a yellow or red light to indicate the gear is up or in transit. Those factory systems that do have an alert, such as the Piper Arrow™ aircraft, typically operate by sounding an alert when the airspeed is below a factory set value and the power is reduced below a factory set value. These systems are far from ideal, and are often over-ridden by pilots in the field; for example, to allow a pilot the ability to train for required maneuvers, such as slow flight at high altitude.

The smart device 10, through much richer monitoring of more aspects of aircraft condition, allows a better, more accurate, more useful system for detecting whether a gear down scenario is required. Aspects of aircraft condition applicable to the proper time to put the gear down can include:
If Altitude is not near the ground, then the aircraft is not landing, having gear down is generally not desirable. Thus, monitoring Altitude Above Ground Level (AGL) is one indication to check gear.
If the aircraft is not descending, then the aircraft is not landing. Thus, having a negative vertical speed is one indication to check gear.
If the aircraft is at a high cruise speed, then the aircraft is not landing. Thus, monitoring airspeed in knots (KTS) is one indication to check gear.

By monitoring and verifying if the green lights are on or the red lights are on, the smart device 10 knows if the gear is currently down and locked or up.

One embodiment to verify that gear should be down is to combine all of the above into one rule set to know if the gear should be down or not. For example, the inventors implemented a functional electronic device for this use case. The inventors tested the electronic device in a 1979 Beech A36. The electronic device provided a “Check Landing Gear” audible alert to sound when the following conditions were met:

Altitude is less than 1200′ AGL

Vertical Speed is less than −200 ft/min

Airspeed is less than 120 kts.

The values provided above are exemplary values and are not meant to be limiting. Based on the above values, a rule can be created for the rule module discussed earlier. It is envisioned that the monitoring of current gear position can be added. As each of these conditions and condition limits for alert can be adjustable in implementations of the electronic device, the device is far superior to anything on the market today. Moreover, additional warning systems can be added to mimic a virtual co-pilot.

A rule is logic to determine what recommended actions and/or alerts and/or log entries are created. The monitoring of sensor data, the determining of an aircraft condition, and the alerting of the pilot is done on a continuous, near real-time basis. A recommended action is a recommended response to a rule or set of rules being triggered or traversed as defined in a rule.

B. Safety Warning System—Stall/Spin—Virtual Co-Pilot

A significant number of accidents in general aviation aircraft are a stall and spin that occurs low to the ground when turning base to final to line up with a runway and land. The accident can occur because of pilot distraction or can occur from a tightening of a turn because the pilot overshot runway alignment due to poor technique or due to wind blowing the aircraft further than anticipated into the turn. According to a study by the Air Safety Foundation of 450 stall spin accidents from 1993 to 2001, 80% of them started from an altitude of less than 1000′ AGL, which is the pattern/landing altitude at most airports. In a 1970's study by NASA looking at altitude loss in spins of several aircraft, the Piper Arrow, a common general aviation aircraft, lost an average of 1160′ in a spin when flown by a professional test pilot. The average private pilot can be assumed to not do as well.

The typical aircraft has a stall indicator that works by sounding an alarm when a wing stalls and has an airspeed indication for stall speed in various configurations (flaps down or flaps up). The issue with existing systems is that stall speed is dependent on several factors that are not taken into account by the airspeed indicator. One of these factors is bank angle. When a wing is banked 45°, stall speed increases by 20%; when banked 60°, stall speed increases by 40%. As speed is already decreased to prepare for landing at this point, the more the pilot tries to tighten the turn to final, the more likely the aircraft is to stall.

It is envisioned that the smart device 10 can help solve this problem through a rule set and by informing the pilot what action to take, rather than just what problem is occurring. Using the Beech A36 for the example, the rule set might include:

altitude below 1500′ AGL,

airspeed below 120 kts,

aircraft bank angle over 30°,

gear is down (if retractable),

The result could be either sounding an alert or instructing the pilot to reduce bank angle to avoid a stall/spin.

C. Company or Organization Operations and/or Safety Compliance Monitoring and Logging—Virtual Boss

Many aircraft are owned by organizations such as companies, flying clubs, or flight schools. As operator representatives do not often fly along on most flights, it is an “honor system” to verify that the pilot is actually operating the aircraft in a safe, mechanically sound, and per company/club/school procedure.

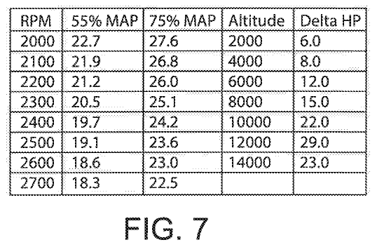

For example, aircraft engines need to be rebuilt, typically every 2000 hours of operation or so. How the engine is operated has a very large impact on how long the engine will last. For example, operating at 75% power vs. 65% power will significantly reduce engine life and increase operating expenses. As aircraft operate in many different altitudes and with associated different air densities, correctly setting the power depends on several variables. A typical operator policy would be to not operate the engine in cruise at more than 65% power, regardless of altitude. FIG. 7 provides the power-setting table for a Lycoming O-320 engine.

Implementations of the smart device 10 can help operators verify proper operation of their aircraft by several means, including:
recommending proper setting for RPM and manifold pressure (MP) to set for the desired altitude and power setting for cruise flight when a cruise aircraft condition occurs,
recommending a change in power setting when altitude changes and a cruise aircraft condition occurs,
logging actual operation to verify it complies with operator rules, and
logging actual operation to be shared by interested parties, such as an industry group or type club that operates similar aircraft.

Another related example is that when the proper RPM and MP are set, as well as the fuel/air mixture is properly leaned, these result in an acceptable exhaust gas temperature (EGT) and cylinder head temperature (CHT) of the engine. In one implementation, the smart device 10 can monitor the EGT and CHT of each cylinder and, if an abnormal condition occurs, instruct the pilot what to change, such as leaning or enrichening the mixture control.

D. Training Step by Step Coach, Recommend and Monitor—Virtual CFI

Pilot training is an expensive and laborious task. It is not unusual for someone training to be an airline transport pilot (ATP) to spend over $100,000 for completing the required training. In embodiments, the invention can be used to standardize in-air or in-simulator training syllabus and methods, saving significant costs for the operator in training operator and saving time and cost for the trainee.

For example, the smart device 10 can be programmed with sequential aircraft conditions and rule sets for each maneuver to be trained. For a more specific example, one required training maneuver is the power-off stall. The manual steps required of the pilot to successfully accomplish a power-off stall in a Piper Archer aircraft include the following
1. This entire maneuver is required to be accomplished at a minimum altitude of 1500′AGL.
2. Establish straight and level flight on a cardinal heading (North, South, East or West) at cruise speed of 105 kts.
3. Perform a clearing turn, either a 180° turn or two 90° turns without changing altitude more than 100′.
4. Reduce power to idle.
5. Use the control yoke to maintain elevation in order to slow down.
6. Once down to Vy speed=76 kts (best climb), put the nose down to maintain that speed and add power to 1300-1400 RPM.
7. Upon reaching the desired stall altitude, reduce power to idle, hold altitude with the control yoke by continually increasing pitch attitude until the stall alert goes off.
8. Recover from the stall with minimal altitude loss by adding full power and slightly reducing the pitch attitude.

For training/learning purposes, each of these steps could be programmed into a rule set and presented audibly, visually, or otherwise to the student pilot flying with a Certified Flight Instructor (CFI). This would greatly reduce workload on the CFI, as they are responsible for not only talking the student through each step of the maneuver, but also looking outside the aircraft for traffic avoidance and monitoring/correcting the student's actions. In addition, since prompting will be consistent for each trial of the maneuver, training time will be reduced, and nothing will be missed due to distractions of the CFI.

E. Training Progress Monitoring and Logging—Virtual CFI

In the training scenario for power-off stall discussed above, in order to pass a pilot practical test, each portion of each maneuver must be performed to FAA stated minimal criteria. When a student is first learning, the number of things to pay attention to simultaneously, such as airspeed, pitch attitude, gear, flap position, and more, are overwhelming. Accordingly, training often starts with the student pilot controlling fewer variables, such as the control yoke, and the CFI controlling other variables, such as throttle settings. As the student progresses in abilities, his workload is increased.

In implementations, the smart device 10 can be used to track and log progress. For example, as the student continues taking lessons, they progress from being able to hold altitude within 300′ to within 200′. Each flight performance can be logged. Then, the maneuver rule set can be changed to both standardize when the student is ready to have additional workload added, and the standard limits for “success” in the maneuver can be tightened.

F. Training Progress—Solo Virtual Copilot

Once a student pilot has reached the stage where they can demonstrate maneuvers in a safe manner, but not yet to the standards of a certified private pilot, the student pilot is allowed to take an aircraft solo. This allows the student pilot to practice for increasing proficiency until the student pilot is ready to demonstrate full proficiency to an instructor. The student pilot can then be assigned to take the practical test with an FAA designated examiner.

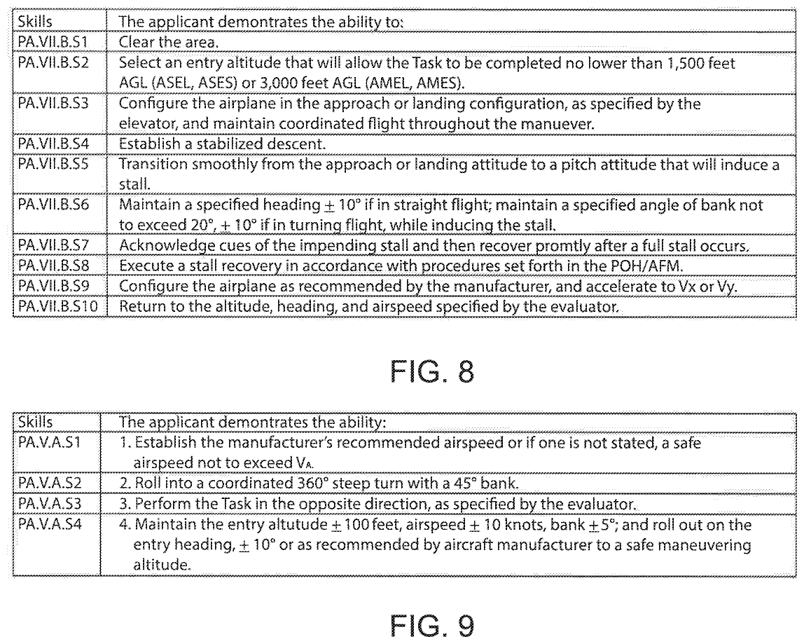

Implementations of the smart device 10 can act as a sophisticated, automated monitor, much like the onboard diagnostics (OBD) device in a car that is now sometimes tied to a logging device for auto insurance. In this case, the rules set would match the FAA airman certification standard (ACS) requirements for each maneuver. Again, using the power-off stall example from above, the ACS standards for a private pilot practical test are in FIG. 8.

The combination of these requirements could be incorporated into a rule set, with warnings or alerts when they are exceeded, as well as recommended actions to improve performance in near real time. For example, if the aircraft deviated more than 7° from the desired heading, a “turn right 7°” recommendation could be given. This near real time feedback would be instrumental in significantly reducing training time and cost.

G. Training Accomplishment Testing—Virtual DPE

In the training scenario for power-off stall discussed above, in order to pass a pilot practical test, each portion of each maneuver must be performed to FAA stated minimal criteria. For example, for the private pilot certificate, the general criteria are that the pilot must maintain heading within 10°, altitude within +−100′, bank angle within +−10°. For airspeed, for most maneuvers, the requirement is +−10 kts, but when landing, it is −0, +10 kts, as getting slow on landing can lead to that stall/spin.

Most student pilots train with one instructor until that instructor feels they are ready to take the practical test. Many flight schools then have the student fly with another instructor to verify proficiency, as well as review training from the primary instructor. The smart device 10 would allow that step to be skipped entirely, as the collected “electronic logs” of the student's solo practice flights could be used to fully demonstrate proficiency for all required maneuvers. The student will know before they take the test that they meet FAA requirements, and are highly likely to pass the practical test.

Embodiments of the invention has many possible use cases, with differing desired outcomes, depending on what the aircraft condition, or what the alert type, or what the pilot or operator desires as the recommended solution to an alert. Embodiments of the present invention allow the pilot or aircraft owner/operator to define what the further response(s) should be for each aircraft condition.

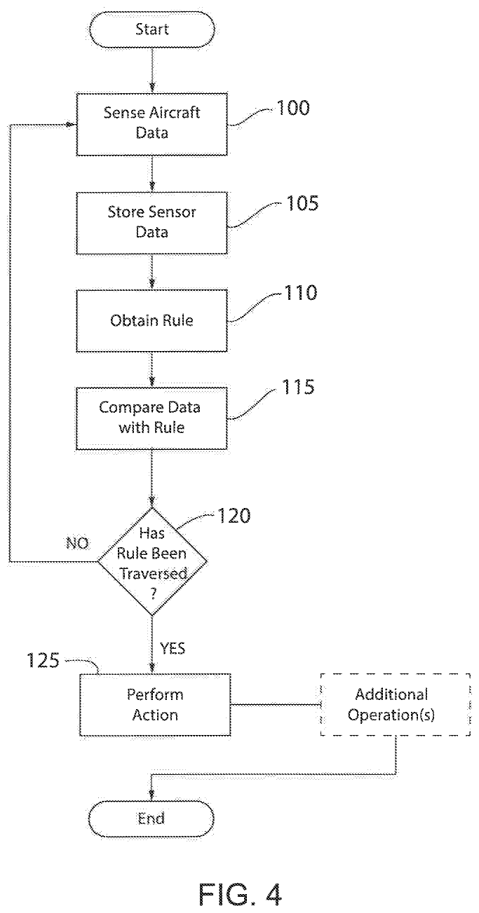

One exemplary operation is shown in connection with reference to FIG. 4. At block 100, the smart device 10 senses aircraft data with the internal and/or external sensors 55 and/or 70. At block 105, the smart device 10 stores the sensor data in memory 40. Periodically, the smart device 10 obtains one or more rules from a rule library (block 110). Each rule defines an aircraft condition (or state) based on various combinations of sensor parameters. Each rule also correlates to an action (e.g. defining a desired notification and/or action for the pilot) when the rule is met or not met. Whether a rule is met or not met is a matter of perspective and how an artisan defines the rule. Collectively, whether a rule is met or not met will be referred to herein as the rule being traversed.

Next, the method compares the sensor data with the rule (block 115). The smart device 10 monitors (block 120) whether the rule has been traversed by the aircraft data. When the rule has been traversed, then the smart device 10 can perform the related action (block 125) for the rule. For example, the smart device 10 can communicate an alarm. The various operations of the method shown in FIG. 4 can be performed by the modules shown in FIG. 2. The method can continue to perform other steps, including monitoring for the desired action or communicate with the aircraft to perform the action. For example, block 130 references additional operation(s) that can be performed by the smart device 10.

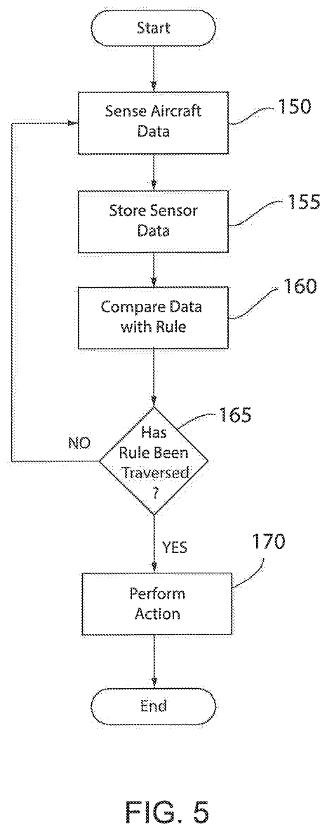

FIG. 5 provides first exemplary additional operations that can be performed by the smart device 10. With reference to FIG. 5, at blocks 150 and 155, the smart device 10 can continue to sense and store aircraft data from the internal and/or external sensors 55 and/or 70 to the memory 40. Next, the method again compares the sensor data with the rule (block 160). The smart device 10 monitors (block 165) whether the rule has been traversed again by the aircraft data. More specifically, the smart device 10 can monitor whether the rule has be traversed in the logically-opposite direction from the traversal in block 120. When the rule has been traversed the second time, then the smart device 10 can cease performing the related action (block 170) for the rule. For example, the smart device 10 can cease communicating the alarm. The various operations of the method shown in FIG. 5 can be performed by the modules shown in FIG. 2.

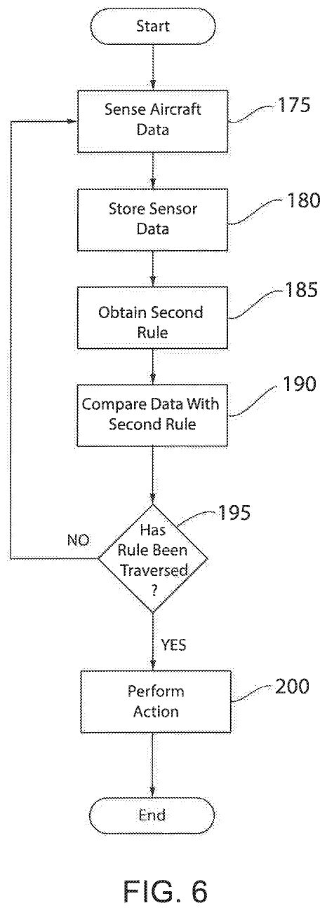

FIG. 6 provides second exemplary additional operations that can be performed by the smart device 10. With reference to FIG. 6, at blocks 175 and 180, the smart device 10 can continue to sense and store aircraft data from the internal and/or external sensors 55 and/or 70 to the memory 40. Next, the smart device 10 obtains one or more second rules from the rule library (block 185). Each second rule defines a further aircraft condition (or state) to be monitored for only after the rule in block 120 has been traversed. Each second rule also correlates to an action (e.g. defining a desired notification and/or action for the pilot) when the second rule is met or not met. Again, whether a second rule is met or not met is a matter of perspective and how an artisan defines the rule. Collectively, whether a second rule is met or not met will be referred to herein as the second rule being traversed.

The smart device 10 monitors (block 190) whether the second rule has been traversed by the aircraft data. When the second rule has been traversed (block 195), then the smart device 10 can perform the related action (block 200) for the second rule. The various operations of the method shown in FIG. 6 can be performed by the modules shown in FIG. 2.

Accordingly and as shown by FIGS. 5 and 6, monitored aircraft conditions can be subsets or supersets of other aircraft conditions. Moreover, rules can be subsets or supersets of other rules. While not exhaustive, some of the additional response rules include: auto clearing an alert; auto modifying an alert; providing positive feedback to pilot actions or changing aircraft status; changing recommendations as sensor data or aircraft conditions change; providing coaching/recommendations on a series of events for a maneuver; logging alerts, recommendations, pilot actions and timing for later analysis and review by the pilot or owner/operator; various combinations of the above as desired by owner/operator.

The inclusion of a remote aviation database 85 (FIG. 3) allows flight departments or aircraft manufacturers to define their own desired rules, pilot notifications, and actions. In implementations, the smart device 10 proactively notify/tell the pilot what to do in a given situation in real time, similar to the function performed by a co-pilot, or even a flight instructor.

Below are more specific examples of use cases that can be performed by embodiments of the invention. The additional use cases below are typical, but not inclusive, and may not be appropriate in all situations (for example, response to an excessive bank in a turn alert, or even whether that alert occurs, may be very different for a general civil aviation aircraft than for a military aircraft in a dog fight).

I. Safety Warning System—Gear Alerting—Virtual Copilot—Self Clearing or Manual Clearing

For some types of alerts, best design might be that when the aircraft condition being alerted ceases to occur, the alert self-clears, or goes away. An example of this is that if the “gear is up, lower the gear” alert is on, and the pilot then lowers the gear. When the system senses that the gear is in transit or that the three green lights indicating that the gear is now down and locked occurs, then the alert changes to “gear in transit” or stops automatically.

As an example that there may be multiple means of clearing a single alert using the same “gear is up, lower the gear” use case. In the situation where there is an electrical or hydraulic problem, and the gear cannot be lowered, then the pilot might manually extinguish the alert, as the normal method of automatically extinguishing the alert may not be possible.

So the invention allows for an alert clearing rule set that may include multiple logical paths/options to clear the alert.

II. Safety Warning System—Stall/Spin—Virtual Co-Pilot—Recognition of Correction with or without Coaching Response and Logging

Since aircraft condition is monitored near real time, as alerts or warning conditions occur, not only can the pilot be alerted, but as the condition continues and the pilot responds by changing the aircraft condition, such as adding power or reducing bank, the system can follow a condition response rule set. An example rule set may include:
Alert the pilot to the problem, in this example, “excessive bank near the ground”
Tell the pilot what action to take to correct a condition “reduce bank”
Monitoring whether/when the correction is applied
When the condition has been corrected, in this example, bank reduced to less than 30 degrees, tell the pilot “bank reduced”.

So in the safety example where the smart device 10 warns the pilot of too much bank on the turn to final, if the pilot then corrects that situation, the smart device 10 could extinguish the alert, or even provide a corrected alert such as the warning being “too much bank, reduce bank”, and when the pile does that, announce “bank reduced” or something similar.

This example would also be very helpful in training situations, especially when flying solo, to let the student pilot know they have corrected the issue. The smart device 10 could even have different notifications when corrected “within FAA specs” or “Corrected, outside of FAA specs”, or notify by how much specs were exceeded.

III. Company or Organization Operations and/or Safety Compliance Monitoring and Logging—Virtual Boss

The additional steps taken by the pilot, as well as all the messages given to the pilot, as well as flight log data, such as GPS speed, altitude, pitch, bank, etc, can be included in the log files to track pilot compliance to company procedures.

So for example using the power setting based on flight phase of cruise and cruise altitude, instead of just logging that “Power setting above 65% in Cruise” was a rule that was traversed, the log could be enhanced with more data to something along the lines of “cruise power setting of 65% exceeded to 85% at cruise altitude of XXXX′ for time period of YYY minutes, pilot corrected within 30 seconds of alert”.

This would give owner operators a much richer understanding of not only whether their pilots were flying within company specified parameters, but also whether when alerted, the pilots took prompt action to attempt to operate within parameters. Moreover, the smart device 10 also greatly enhances understanding of the value of the invention in related to maintenance savings of the company's aircraft(s).

IV. Training Step by Step Coach, Recommend and Monitor—Virtual CFI; Training Progress Monitoring and Logging—Virtual CFI; Training Progress—Solo Virtual Copilot; Training Accomplishment Testing—Virtual DPE

This example combines aspects of the above use cases to show a representative complement of possible post alert processing. The below example is certainly not exhaustive.

For training purposes, not only alerting pilot trainees to issues, but also alerting when FAA criteria are about to be exceeded, before they are exceeded, coaching the pilot on the correct action to resolve the issue, and letting the pilot know when (s)he has taken appropriate corrective actions, are invaluable training aids.

As an example, one required maneuver for private pilot training is a steep turn. FAA requirements for the steep turn maneuver are shown in FIG. 9.

As the maneuver is initiated, a rule set that monitors the FAA requirements can begin. While the maneuver progresses, there can be a combination of alerts, alert clearing, alert modifications, coaching suggestions and logging occurring. The following is an example of full alert/coaching/logging for a sample steep turn.
[Alert]—Maneuver might be started with excessive speed, resulting in an “Excessive Speed” alert
[Alert Recommendation]—If in training mode, a “Reduce Power” coaching alert might be given
[Alert Clearing and Alert Coaching]—Pilot might then reduce speed, which would both clear the “Excessive Speed” alert and offer a “Speed Reduced” or “Speed In Specs” notification
[Pre-alert warning and Coaching]—As the maneuver progresses, Altitude might become 70′ low, with the FAA requirement of remaining within 100′, so a warning of “Altitude 70′ low, increase altitude” message would be given
[Pre-alert modification]—As the pilot corrects altitude and becomes 50′ low, an “Altitude 50′ low, increase altitude” message would be given
[Pre-Alert Clearing and/or Coaching]—Once within 30′ of correct altitude, the Pre-Alert could clear itself or provide positive reinforcement with an “Altitude Corrected” message
[Alert Coaching and Logging]—Assuming the rest of the maneuver completed successfully, the pilot would get a “Steep Turn Began With Excessive Speed” message, and the entire data on the maneuver could be logged, including start/stop times, that it traversed the Excessive Speed rule, that the pilot was prompted to slow down, how many seconds it took to slow down (to measure future training progress) and that no other alerts were generated. Could also log that a “Low Altitude” warning was given on the maneuver, and that the pilot corrected the situation without exceeding FAA limits.

Similarly, logging of progress, whether within FAA criteria or not, over time, has great value. If a corrective response to an alert took 5 seconds during lesson 1 and 0.3 seconds on lesson 10, the student is showing great progress and increased situational awareness. For this use case, additional functionality is monitoring and logging not only alerts, but also responds to those alerts. The logging of progress can include storing of any combination of recommended action, alert, log, aircraft condition, any sensor data, or other available data, such as time/date related to any combination of recommended action, alert, log, aircraft condition, sensor data, or other available data. The logging of information in other uses can similarly log this just-specified information.

As discussed above, one or more rules may be triggered at any given time, and rules can be subsets or supersets of other rules. It is also contemplated that rules have logic to determine what recommended action, alert, and/or log, if any, should take priority if multiple rules are triggered concurrently (e.g., simultaneously). For example, if three rules have been traversed at the same time, the smart device 10 can recommend an action, alert, and/or log for each traversed rule concurrently, in an order of priority, or a combination thereof (e.g., issue a first alarm until resolve, and then issue the two remaining alarms). The smart device 10 monitors and recommends actions/alerts/logs as flight progresses and sensor data changes due to changes in wind, weather, aircraft performance, and pilot actions.

Rules may also be broken into categories that may work together or independently to define what rules are currently active. For example, one category may be general rules that apply regardless of the situation. Another category may be pilot based rules—either individually or as a class (or group). Another category may be aircraft based rules, and yet another category may be sensor-based rules. Even further categories are envisioned and possible.

There are virtually innumerable uses for the present invention, not all of which need be detailed here. Additionally, all the disclosed embodiments can be practiced without undue experimentation. Further, although the best mode contemplated by the inventors of carrying out the present invention is disclosed herein, practice of the present invention is not limited thereto. For example, it will be manifest that various additions, modifications, and rearrangements of the features of the present invention may be made without deviating from the spirit and scope of the underlying inventive concept.

In addition, the individual components need not be assembled in the disclosed configuration but could be assembled in virtually any configuration. Furthermore, all the disclosed features of each disclosed embodiment can be combined with, or substituted for, the disclosed features of every other disclosed embodiment except where such features are mutually exclusive.

Aspects of certain embodiments described herein may be implemented as software modules or components. As used herein, a software module or component may include any type of computer instruction or computer-executable code located within or on a computer-readable storage medium, such as a non-transitory computer-readable medium. A software module may, for instance, comprise one or more physical or logical blocks of computer instructions, which may be organized as a routine, program, object, component, data structure, etc., which perform one or more tasks or implement particular data types, algorithms, and/or methods.

A particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the maintenance conditions enabling the implementation of the methods described herein and which, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” includes a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in a combination of one or more programming languages, including an object-oriented programming language such as Java™, Smalltalk, C++ or the like and conventional procedural programming languages, such as the “C” programming language or similar programming languages. The program code may be executed entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer, for example, through the Internet using an Internet Service Provider.

The terms “a” and “an”, as used herein, are defined as one or more than one. The term “plurality”, as used herein, is defined as two or more than two. The term “another”, as used herein, is defined as at least a second or more. The terms “including” and/or “having”, as used herein, are defined as comprising, i.e., open language. The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC, or ABC).

What is claimed is:

1. A standalone electronic device for generating a communication while in an aircraft, the device comprising:
a processor; and
a memory communicably coupled to the processor and storing:
an aircraft data module including instructions that when executed by the processor cause the processor to obtain aircraft data, the aircraft data being obtained from one or more sensors supported by the standalone electronic device, from one or more sensors of the aircraft, or from both the one or more sensors supported by the standalone electronic device and the one or more sensors of the aircraft;
a rules module including instructions that when executed by the processor cause the processor to obtain a rule defining an aircraft state;
a monitoring module including instructions that when executed by the processor cause the processor to monitor whether the rule has been traversed by the aircraft data; and
an output module including instructions that when executed by the processor cause the processor to generate a communication output upon the rule being traversed.

2. The device of claim 1, wherein the monitoring module further includes instructions that when executed by the processor cause the processor to monitor whether the rule has been traversed a second time by the aircraft data, and
wherein then output module further includes instructions that when executed by the processor cause the processor to generate a second communication output upon the rule being traversed the second time by the aircraft data.

3. The device of claim 2, wherein the second communication output is the cessation of the first communication output.

4. The device of claim 2, wherein the traversal of the rule the second time is in a logically-opposite direction from the traversal of the rule the first time.

5. The device of claim 1, wherein the rules module further includes instructions that when executed by the processor cause the processor to obtain a second rule defining a second aircraft state,
wherein the monitoring module further includes instructions that when executed by the processor cause the processor to monitor whether the second rule has been traversed by the air craft data only after the first rule has been traversed by the aircraft data, and
wherein the output module further includes instructions that when executed by the processor cause the processor to generate a second communication output upon the second rule being traversed.

6. The device of claim 1, wherein the one or more sensors supported by the standalone electronic device includes a sensor selected from the group consisting of a Global Positioning System (GPS) sensor, a pressure sensor, a compass, an accelerometer, a gyroscope, and more.

7. The device of claim 1, wherein the one or more sensors supported of the aircraft includes a sensor selected from the group consisting of avionic sensors, a GPS sensor, an attitude and heading reference sensor (AHRS), a pitot static sensor, and an aircraft engine data sensor.

8. The device of claim 1, wherein the rule defines a state of the landing gear up during a landing process.

9. The device of claim 1, wherein the rule defines a state of the aircraft and wherein the communication output includes a message to change the state of the aircraft.

10. The device of claim 1, wherein the communication output includes a visual output.

11. The device of claim 1, wherein the communication output includes an audible output.

12. A method of generating a communication with a standalone electronic device while in an aircraft, the method comprising:
obtaining aircraft data, the aircraft data being obtained from one or more sensors supported by the standalone electronic device, from one or more sensors of the aircraft, or from both the one or more sensors supported by the standalone electronic device and the one or more sensors of the aircraft;
obtaining a rule defining an aircraft state;
monitoring whether the rule has been traversed by the aircraft data; and
generating a communication output upon the rule being traversed

13. The method of claim 12, further comprising:
monitoring whether the rule has been traversed a second time by the aircraft data; and
generating a second communication output upon the rule being traversed the second time by the aircraft data.

14. The method of claim 12, further comprising:
monitoring whether the rule has been traversed a second time by the aircraft data; and
generating a second communication output upon the rule being traversed the second time by the aircraft data.

15. The method of claim 12, wherein the rule defines a safety warning for the aircraft, and
wherein monitoring whether the rule has been traversed includes determining whether the safety warning for the aircraft has been traversed.

16. The method of claim 12, wherein the rule defines a compliance requirement for the aircraft,
wherein monitoring whether the rule has been traversed includes determining whether the compliance requirement for the aircraft has been traversed, and
the method further comprises logging the traversal of the compliance requirement.

17. The method of claim 12, wherein the rule defines a compliance requirement for the aircraft,
wherein monitoring whether the rule has been traversed includes determining whether the compliance requirement for the aircraft has been traversed, and
the method further comprises logging the traversal of the compliance requirement.

18. The method of claim 12, further comprising defining a virtual coach having a plurality of rules, where monitoring whether the rule has been traversed includes determining whether one of the plurality of rules has been traversed.

19. A non-transitory computer-readable medium that stores machine readable instructions that when executed by a processor of a standalone electronic device from an aircraft cause the processor to:
obtain aircraft data, the aircraft data being obtained from one or more sensors supported by the standalone electronic device, from one or more sensors of the aircraft, or from both the one or more sensors supported by the standalone electronic device and the one or more sensors of the aircraft;
obtain a rule defining an aircraft state;
monitor whether the rule has been traversed with the aircraft data; and
generate a communication output upon the rule being traversed.

20. The non-transitory computer-re readable medium of claim 18, wherein the medium further stores machine readable instructions that when executed by a processor of a standalone electronic device from an aircraft cause the processor to:
monitor whether the rule has been traversed a second time by the aircraft data; and
generate a second communication output upon the rule being traversed the second time by the aircraft data.

21. The non-transitory computer-re readable medium of claim 18, wherein the medium further stores machine readable instructions that when executed by a processor of a standalone electronic device from an aircraft cause the processor to:
monitor whether the second rule has been traversed by the air craft data only after the first rule has been traversed by the aircraft data; and
generate a second communication output upon the second rule being traversed.

22. A method of generating a communication with a standalone electronic device while in an aircraft, the method comprising:
obtaining aircraft data, the aircraft data being obtained from one or more sensors supported by the standalone electronic device, from one or more sensors of the aircraft, or from both the one or more sensors supported by the standalone electronic device and the one or more sensors of the aircraft;
obtaining a rule defining an aircraft state;
monitoring whether the rule has been traversed a first time by the aircraft data;
generating a first communication output upon the rule being traversed the first time;
monitoring whether the rule has been traversed a second time by the aircraft data; and
generating a second communication output upon the rule being traversed the second time.

23. A method of generating a communication with a standalone electronic device while in an aircraft, the method comprising:
obtaining aircraft data, the aircraft data being obtained from one or more sensors supported by the standalone electronic device, from one or more sensors of the aircraft, or from both the one or more sensors supported by the standalone electronic device and the one or more sensors of the aircraft;
obtaining a first rule defining an aircraft state;
monitoring whether the first rule has been traversed by the aircraft data;
generating a first communication output upon the first rule being traversed;
obtaining a second rule defining a second aircraft state;
monitoring whether the second rule has been traversed by the aircraft data only after the first rule has been traversed by the aircraft data; and
generating a second communication output upon the second rule being traversed.
